(19) United States
(12) Patent Application Publication
(10) Pub. No.: US 2021/0138367 A1
(43) Pub. Date: May 13, 2021

(54) DEVICE AND A METHOD FOR INSTALLING A FILTER BAG OF A DISC FILTER

(71) Applicant: VALMET TECHNOLOGIES OY, Espoo (FI)

(72) Inventor: Teemu Antikainen, Espoo (FI)

(21) Appl. No.: 16/622,700

(22) PCT Filed: Jun. 25, 2018
(86) PCT No.: PCT/FI2018/050490

§ 371 Date: Dec. 13, 2019

(30) Foreign Application Priority Data
Jun. 26, 2017 (FI) 20175603

(51) Int. Cl. B01D 33/23; B25B 5/00

(52) U.S. Cl. CPC B01D 33/23; B01D 29/413; B25B 5/006

(57) ABSTRACT

The present invention relates to a device (14) and a method for installing a filter bag having an open end on a sector (5) of a disc filter (1). The device (14) comprises a substantially horizontal elongated body (15) having a first end and a second end and at least three clamping devices (16) attached to the body (15). Each clamping device (16) comprises a substantially vertical supporting leg (17). The device (14) comprises a suspension arrangement for the filter bag at both ends of the body (15).

### FIELD OF THE INVENTION

The present invention relates to a device and a method for installing a filter bag of a disc filter.

### BACKGROUND OF THE INVENTION

A common manner to install a filter bag is to pull the bag manually on a sector of a disc filter. It is difficult to draw the filter bag properly manually. It is hard work and the work must be done rapidly. The work may cause repetitive strain injuries.

The quality of the work depends on the carefulness of the worker. If the fabric of the filter bag is not evenly tight there may be folds on the surface of the fabric which accelerates the wear of the filter bag.

### BRIEF DESCRIPTION OF THE INVENTION

An object of the present invention to provide a device and a method so as to overcome the above problems. The objects of the invention are achieved by a device and a method which are characterized by what is stated in the independent claims. The preferred embodiments of the invention are disclosed in the dependent claims.

The invention is based on the idea of closing the filter bag in stages.

An advantage of the installing device and the method is that the installation work eases up and quickens. A user of the device contacts less e.g. dressed ore of a filtration process. The quality of the installation work becomes better which leads to the fact that the filter bags do not wear as before. The device requires neither electricity nor compressed air. The device is easy to transfer from place to place.

The position of each part and their directions are described in this text as they are during the installation work.

The device for installing the filter bag on a sector of a disc filter comprises a substantially horizontal elongated body having a first end and a second end, i.e. the body is preferably a rod or a bar. The device comprises at least three clamping devices attached to the body and extending through the body. Each clamping device comprises a substantially vertical supporting leg and a suspension arrangement for the filter bag at both ends of the body. The suspension arrangement is attached to the filter bag e.g. by loops sewn to the filter bag. The supporting leg contacts the upper edge of the sector by its counterpart which dimensions fit to the upper edge. As one is using the clamping devices, the supporting legs start to push the upper edge of the sector. The filter bag rises upwards and tightens. After that it is possible to close the filter bag in stages by using the clamping devices in a certain manner described in details below.

### BRIEF DESCRIPTION OF THE DRAWINGS

In the following the invention will be described by means of preferred embodiments with reference to the attached drawings, in which

FIG. 1 shows a principle of a disc filter in a two dimensional view;

FIG. 2 shows an installing device in a perspective view.

### DETAILED DESCRIPTION OF THE INVENTION

FIG. 1 shows a principle of a disc filter in a two dimensional view. The disc filter 1 which comprises a reservoir 2 whereto a solution formed by a solid matter and liquid is supplied for processing from a feed channel 3. It is to be noted that typically the surface of the solution contained in the reservoir 2 is lower than what is shown herein. Further, the disc filter 1 comprises a frame part 4 rotatable around a horizontal axis.

The frame part 4 may be formed from one tubular piece or, alternatively, it may be formed from several tubes 4a. The outer circumference of the frame part 4 is provided with several, substantially triangular sectors 5 side by side, whereby the sectors 5 form a relatively narrow, disc-like structure around the frame part 4. One frame part 4 may comprise several such disc-like structures arranged at an axial distance from one another. Triangular side surfaces 6 of each sector 5 are provided with openings 7.

Against a side surface 6 there is a filter fabric of a filter bag 8 which serves as a filtering layer. The frame part 4 of the disc filter is rotated around its longitudinal axis in direction A, whereby each sector 5, each in its turn, becomes immersed in the solution 9 contained in the reservoir 2. Inside the sector 5 immersed in the solution 9, underpressure may be formed via the frame part 4. In such a case, liquid is allowed to pass into the sector 5 through a filter bag 8 made of a solid-liquid filter fabric and further via the openings 7 provided in the side surface 6 of the sector.

Inside the sector 5, the liquid flows influenced by the underpressure along a flow channel 11 to a neck part 12 of the sector 5 and further via the frame part 4 away from the disc filter. The solid matter, in turn, remains on the surface of the filtering cloth 8, wherefrom it may be removed by means of doctor blades 10 or pressure medium sprays into a discharge shaft 13 prior to a next filtering cycle. Alternatively, the cloth is distended by pressure for removing a solid matter cake.

FIG. 2 shows a device 14 for installing a filter bag 8 on a sector 5 of a disc filter 1. The filter bag 8 has an open upper end. The device 14 comprises a substantially horizontal elongated body 15 having a first end and a second end. The body 15 may be made of an aluminum profile. There are at least three clamping devices 16 attached to the body 15. Each clamping device 16 comprises a substantially vertical supporting leg 17 which comprises in its lower end a counterpart 18a, 18b for the upper end of the sector 5, i.e. the counterparts fit together with the upper end of the sector 5 so that the device 14 is firmly attached to the sector 5.

There is also a suspension arrangement for the filter bag at both ends of the body 15. The suspension arrangement comprises a device 19 for hanging the filter bag. The device 19 may be a hook, a loop or a like. Alternatively, the suspension arrangement comprises a device for gripping to the filter bag. Such a device may be a clamp or a like.

The filter bag is first pulled over the sector 5 through its open end and next the installing device 14 is put in place. After the installing device is installed to the upper edge of the sector 5 by the counterparts 18a, 18b the filter bag is attached to the suspension arrangements on both sides of the filter bag 8. In the following step, the filter bag is drawn by the installing device 14 in such a manner that a user of the device 14 clamps the handles 20 of the clamping devices 16a, 16b, 16c. The supporting legs 17 push downwards, thus pulling the filter bag tight and its surface flat. The clamping devices 16a, 16b, 16c function in practice like a manual caulking gun.

After the filter bag is evaluated to be tight enough the first clamping device 16a is released so that one can close the filter bag between the first clamping device 16a and the second clamping device 16b.

The first clamping device 16a is attached to the sector 5 covered by the filter cloth and the second clamping device 16b is released. Then the filter bag is closed between the second clamping device 16b and the third clamping device 16c. Next the installing device 14 is removed and the rest of the open end of the filter bag is closed.

If the open end of the filter bag 8 is provided with a zipper one must check that the beginning of the zipper on the right side relative to the installing device 14.

It will be obvious to a person skilled in the art that, as the technology advances, the inventive concept can be implemented in various ways. The invention and its embodiments are not limited to the examples described above but may vary within the scope of the claims.

1. A device (14) for installing a filter bag (8) having an open end on a sector (5) of a disc filter (1), the device (14) comprises
a substantially horizontal elongated body (15) having a first end and a second end,
at least three clamping devices (16) attached to the body (15), each clamping device (16) comprising a substantially vertical supporting leg (17), which comprises in its lower end a counterpart (18a, 18b) for the upper end of the sector (5), and
a suspension arrangement for the filter bag (8) at both ends of the body (15).

2. The device according to claim 1, wherein the suspension arrangement comprises a device (19) for hanging the filter bag (8).

3. The device according to claim 1, wherein the suspension arrangement comprises a device for gripping to the filter bag (8).

4. A method for installing a filter bag (8) having an open end on a sector (5) of a disc filter (1), wherein the filter bag is installed by the device according to claim 1, the method comprising steps accomplished by the device:
the filter bag (8) is drawn by the installing device (14) in such a manner that the open end of the filter bag (8) is closable between the first clamping device (16a) and the second clamping device (16b), and
the filter bag is drawn by the installing device (14) in such a manner that the open end of the filter bag (8) is closable between the second clamping device (16b) and the third clamping device (16c).

5. The method according to claim 4, wherein the filter bag (8) is attached to the installing device (14) before accomplishing the steps by the device.

6. The method according to claim 4, wherein the open end of the filter bag (8) is provided with a zipper and the zipper is closed between the first clamping device (16a) and the second clamping device (16b) followed by closing the zipper between the second clamping device (16b) and the third clamping device (16c).
